(19) United States
(12) Patent Application Publication
(10) Pub. No.: US 2026/0337419 A1
(43) Pub. Date: Oct. 29, 2026

(54) HARD, DURABLE CORROSION INHIBITING POLYMER COATING COMPRISING THE REACTION PRODUCT OF RESIN, A HARDENER AND A PASTE AND USES OF THE SAME

(71) Applicant: The Patent Well LLC, Fort Worth, TX (US)

(72) Inventor: Ryan Merritt, Grapevine, TX (US)

(21) Appl. No.: 19/643,627

(22) Filed: Apr. 9, 2026

Related U.S. Application Data
(60) Provisional application No. 63/794,938, filed on Apr. 25, 2025.

(51) Int. Cl. C09D 5/10; C08G 59/22; C08G 59/50; C08G 59/68; C08K 5/544; C09D 5/08; C09D 7/40; C09D 7/43; C09D 7/62; C09D 7/63; C09D 7/65; C09D 191/00

(52) U.S. Cl. CPC C09D 5/103; C08G 59/22; C08G 59/50; C08G 59/68; C08K 5/544; C09D 5/084; C09D 7/43; C09D 7/62; C09D 7/63; C09D 7/65; C09D 7/70; C09D 191/00; C08K 2201/019

(57) ABSTRACT

Corrosion inhibiting multipart cure in place mixes having a resin, a hardener and a paste (RHP), the paste being either part of the resin or hardener, or a third part in addition to the resin and hardener. When cured the RHP forms a hard coating or reaction product. The RHPs may include metal particles or inert particles, and may also include corrosion inhibitors (in addition to particles or without particles). Some pastes are an organic, carbon-based polymer base such as oily or fatty polymers, lipids, esters.

### CROSS-REFERENCE TO RELATED APPLICATION

This application claims the benefit of U.S. Provisional Patent Application No. 63/794,938 filed Apr. 25, 2025, which is hereby incorporated, and further incorporates by reference U.S. Provisional Patent Application Nos. 63/363,030 filed Apr. 15, 2022 and 63/260,002 filed Aug. 6, 2021, and U.S. patent application Ser. No. 17/817,487 filed Aug. 4, 2022 (U.S. Patent Application Publication no. 2023/0042294).

### BACKGROUND OF THE INVENTION

### Field of the Invention

The present invention generally relates to hard corrosion inhibiting coatings, particularly for aircraft use.

### Description of the Related Art

Corrosion in aircraft is a multibillion-dollar problem and corrosion inhibiting compounds (CICs) or corrosion prevention compounds are a huge industry. There are many possible corrosion sites in an aircraft. CICs are widely used in the aircraft industry to protect aircraft structures, materials, spare parts and assemblies from physical and chemical attack. Direct or close contact between two or more different metal alloys or a metal alloy and a carbon fiber composite material may occur in aircraft. These assemblies are typically subject to environmental and/or mechanical stresses. Joints may include fasteners and/or adhesives for bonding or maintaining two or more discreet panels or members as an integrated assembly. Joint compounds are often required to inhibit corrosion.

A complication in the development of CICs is the desire for them to be environmentally friendly and not hazardous. Unfortunately, some of the best corrosion inhibitors have contained chromates (Cr+6) which present health and environmental concerns. It is no surprise that the development of effective, safe, chromate free CICs has been a difficult task.

Corrosion inhibiting compounds may be classified as multi-component, which may, in some embodiments mix and dry or cure in place on the aircraft part to a hard coat, or single component that may stay moist over time (non-drying) and over a wide variation in temperature.

### SUMMARY OF THE INVENTION

The present invention in various embodiments is generally directed to a number of corrosion inhibiting multipart cure in place mixes comprising at least: a resin, a hardener and a paste, the paste being either part of the resin, or part of the hardener, or a third part in addition to the resin and hardener. The mixes may hereinafter sometimes be referred to as “RHP” (resin, hardener, paste). The mixes may be uncured (when first combined) or cured. When cured they form a hard coating sometimes referred to as the reaction product of a mix of RHP. The term “hard” means harder when compared to any one of the three starting components (resin, hardener, paste) at mixing temperature, as well as the initial viscosity of the mix upon combining of the three, and at least rigid and non-flowable under standard conditions when cured. A hardness range of the cured product is also disclosed herein. Apparatuses for the containment of the separate parts of the mix, and the mixing and application of uncured RHP are disclosed, as well as methods of applying uncured RHP in some embodiments on aircraft assemblies.

The RHPs include a paste having a number of properties, and including and excluding certain components. The paste may include the various embodiments of those pastes disclosed in U.S. Patent Application Publication no. 2023/0042294, incorporated herein by reference. The RHPs include, in some embodiments, particles, including metal particles and inert particles. The RHPs may also include corrosion inhibitors (in addition to particles or without particles).

Some pastes may include an organic, carbon-based polymer base, which may include oily or fatty polymers, lipids, esters, and may be of plant, mineral or animal origin. The organic polymer base may, in some embodiments, have a molecular weight between 500 and 100,000 or more preferably, 5,000 and 75,000. The paste may be non-aqueous, non-toxic, and bio-friendly, and in some embodiments is plant-derived oil.

In some embodiments, the RHP mix includes and one or more additional compositions from one or more of the following three groups: coated or uncoated metal particles, inert particles, and corrosion inhibitors.

Coated or uncoated metal or metal alloy particles may inhibit corrosion of a metallic substrate as, in some embodiments, they may act as sacrificial anodes when the RHP cured coating is on a metal substrate, such as an aluminum (including an aluminum alloy).

The inert materials are termed “inert” as they do not, primarily, or typically, have a significant corrosion inhibiting function. Rather, they may be added primarily for other purposes such as flow characteristics, color, UV inhibitors (blockers), flame and fire retardant purposes, and thickening and sag characteristics.

The corrosion inhibitors are chemicals, usually added in any of the resin, hardener or paste (base) premixing, or added as a separate part when mixing occurs, in some embodiments, as powders, non-metallic (but may include organometallic) compositions that function as corrosion-inhibitors when the cured RHP mix coats a substrate, including a metallic substrate.

The RHP may be free of one, more, or preferably all of the following: chromates, chromium, sulfides, polysulfides, petroleum distillates, and solvents. Chromates and chromium have been said to raise environmental concerns, as have polysulfides. Sulfides may promote drying out. Silicone may affect paint adhesion. Solvents and petroleum distillates may cause environmental and/or adhesion issues.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1A illustrates the use of a 10:1 cartridge with mixing straw as it mixes and applies the uncured mix to an aircraft part.

FIG. 1B illustrates the spreading of the uncured mix on an aircraft part with a spreading tool.

FIG. 1C illustrates the spread and cured reaction product (cured epoxy coating), on the aircraft part.

FIGS. 2A and 2B illustrate the use of the Applicant's coating on upper flying wire attachment assembly before and after exposure to use, all photos on single engine float plane.

FIGS. 2C and 2D illustrate the use of Applicant's coating on a forward spreader bar assembly, before and after exposure.

FIGS. 2E and 2F illustrate the use of Applicant's coating on a lower flying wire attachment assembly, before and after exposure.

FIG. 3 is a cure profile, illustrating storage and loss modulus (and tan delta) v. time as the mix cures.

FIG. 4 is fluid resistance data, spray testing common aircraft fluids.

FIG. 5 is fluid immersion test data, weight change, various common aircraft fluids.

The use of the same reference symbols in different drawings indicates similar or identical items.

### DESCRIPTION OF THE PREFERRED EMBODIMENT(S)

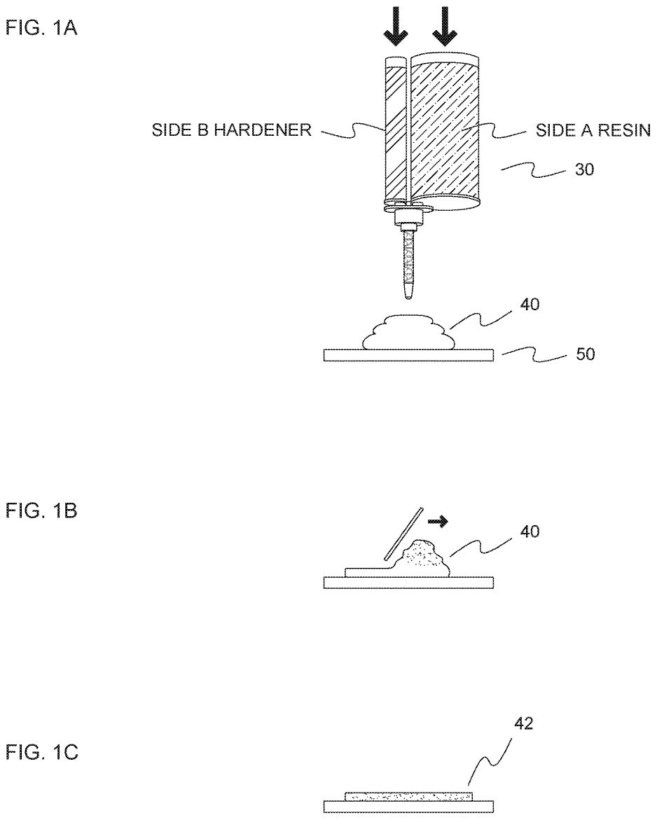

FIG. 1A illustrates a two part applicator 30 for the mixing and application of corrosion inhibiting RHP uncured mix 40 which includes a paste, a resin and a hardener. The paste may include one or more of metal particles, corrosion inhibitors and/or inert materials. The uncured mix 40 is shown on a substrate 50 which may include an aircraft part or the surface thereof, prior to spreading. FIG. 1B, illustrates the uncured mix in the process of being shaped or spread manually with a shaping tool 20 such as a spatula or brush. In FIG. 1C the uncured mix has now cured to a hard epoxy coating 42, also referred to as a reaction product of the uncured mix.

Applicant's corrosion inhibiting pastes typically have a paste consistency, a viscosity in some embodiments between 9,000 and 10,000,000 cP. The uncured mix is, at room temperature, a thick, soft, spreadable, moist substance, that may be dispensed from a container, such as by a spatula or a brush, by squeezing from a tube, cartridge, or applicator (for example, syringe or Semco® type) but will hold its shape after it sets up on and stick to a substrate including a metal such as aluminum alloy or a carbon fiber reinforced plastic substrate. The curing results in a hard epoxy based coating on the part or assembly.

In some embodiments the paste viscosity is between 9,000 and 10,000,000 cP at room temperature and, in some embodiments, may be easily spread at room temperature (no heating required). Viscosity of any of the components of the RHP mix, in some embodiments, may be adjusted by varying the loading of particles.

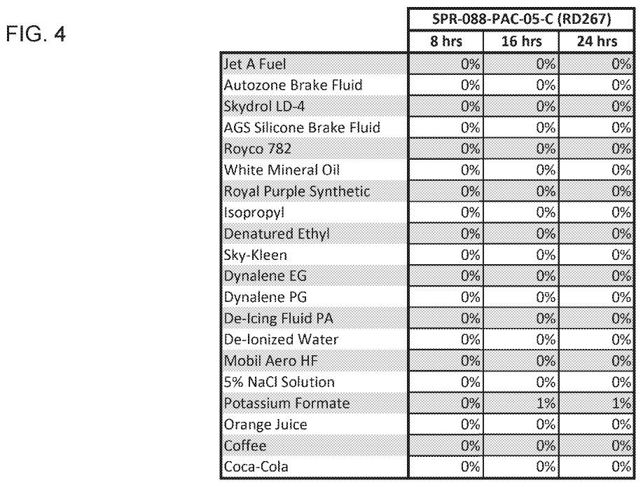

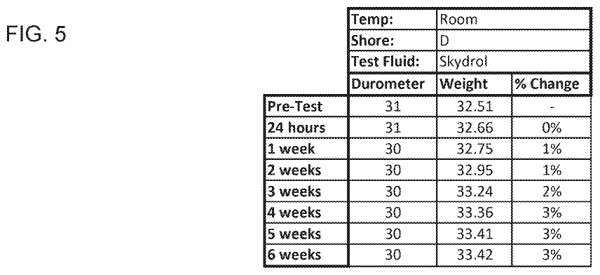

Applicant's corrosion inhibiting cured reaction product of the RHP mix, is able to withstand a wide variety of time-temperature conditions without substantial loss of its chemical and physical properties. The cured coating, in some embodiments, may be able to withstand attack from aircraft fuels (such as Jet A) or other aircraft fluids (including hydraulic fluids, including Skydrol, see FIGS. 4 and 5). It may be hydrophobic and non-hygroscopic.

The corrosion inhibiting mix may include inert material(s), which may include spheres or fibers, such as polymer fibers, including polyethylene, PTFE, polypropylene, HOPE, or polyolefin fibers or a mix thereof. These inert particles may be hydrophilic or hydrophobic. These inert particles may be non-reactive polymer particles with different shapes. These, in some embodiments, may be 0.1 mm long (0.01-1.0 mm range), and 5 microns in diameter (1-10 micron range), having a surface area of 12 m₂/gr. It is believed they help hold the paste together (coherence), especially when the metallic particles are added and may add toughness or flexibility to the product. They are typically non-reactive to other components of the mix and the substrate to which it is applied. The addition of inert materials such as mica and silicates, to the mix, may also add to the toughness of the corrosion inhibiting cured coating or change its flow characteristics. Some inert materials impart flame retardancy to the mix. Titanium dioxide or any inert materials may be added as a colorant.

The cured coating may be used on aircraft surfaces, and such ability to resist corrosion may be demonstrated by no significant visible corrosion (less than about 5% surface area) nor loss of cohesion or adhesion after the following test: 1000-hour salt fog (B117).

The metal particles of the corrosion inhibiting RHP mix, typically but not necessarily as part of the paste, may be metallic particles. The addition of metallic particles to the mix will, primarily, enhance corrosion resistance (including resistance to galvanic corrosion) of the corrosion inhibiting mix as well as help, to some extent, determine the uncured flow characteristics. The metal particles may be flake-like, oblong, rod-shaped, irregular in shape, or spherical. They may be 1 micron to 300 microns in their longest dimension (preferred range 1-200 microns for metallic particles).

In some embodiments the paste component of the RHP mix may be loaded at a weight loading (compared to the total weight of the corrosion inhibiting paste) between 20-95% base, 0.0-80% metal particles (coated, uncoated or a mixture of coated and uncoated), 0.0-40% inert particles, and 0.0-70% corrosion inhibitors (alternately 0.0-40%). The paste ingredients are mixed uniformly so the corrosion inhibiting paste is smooth (homogenous and without lumps). Applicant below provides for an RHP mix wherein the Paste includes both coated aluminum alloy particles, thickeners and a corrosion inhibitor mix, see COB-1 below, and an RHP mix wherein the paste includes corrosion inhibitors (no metal particles) and thickeners see COB-2 below.

Metallic particles may be coated or uncoated metal in some embodiments of aluminum alloy including an alloy of the 2000, 3000, 4000, 5000, 6000, and 7000 series. The particles may be coated with a coating that will inhibit the natural oxidation of the aluminum (or other metal) so as to aid in electrical conductivity when added to the paste. Metallic particles, especially coated aluminum alloy, will function to help the aircraft surface resist galvanic corrosion that may occur when dissimilar metals are close to one another in the presence of an electrolyte. The metallic particles, especially coated aluminum, may act as a sacrificial anode. The metallic particles include the particles set forth in U.S. Pat. Nos. 8,277,688 and 8,262,938, (the “Navy patents”) incorporated herein by reference. These patents disclose coated aluminum alloy particles in a paint binder, acting to inhibit corrosion when the paint is applied to a metal substrate. These patents also disclose the use of magnesium or zinc particles (or alloys thereof), which may be used in the mix.

The referenced Navy patents disclose a number of conductive or semi-conductive coatings for metal particles including aluminum alloy particles. Applicant has found these coated particles remain electrically active when part of the cured coating and help prevent corrosion of metals more cathodic than the particles and/or the metal particle is more anodic than the substrate. These particle coatings may be free of chromates, which can be harmful to the environment. Some of the metal particle coatings are derived from an aqueous trivalent chromium passivation solution. Other metal coatings are free of any chromium, see U.S. patent application Ser. No. 17/655,298, filed Mar. 17, 2022 (for coatings derived from a molybdate solution), incorporated herein by reference. The chromium-free, molybdate-based aluminum alloy reactive liquid aqueous solution is disclosed in U.S. patent application Ser. No. 17/655,298 leaves molybdate oxidation products on aluminum particles may be used in the mix. The particles, coated or uncoated, may be the high silicon aluminum alloy (10-30% Si) particles disclosed in U.S. Pat. No. 11,739,395 incorporated herein by reference.

Corrosion inhibitors (not referring to the metal particles) may be the lithium salt-based inhibitors found in U.S. Patent Application Publication no. 2012/0025142 and U.S. Pat. No. 10,889,723 incorporated herein by reference. Corrosion inhibitors may be one or more polycarboxylates and may also include synergistic polycarboxylate blends as found in U.S. Patent Application Publication no. 2018/0282555 incorporated herein by reference. Other corrosion inhibitors may be found in the following Navy publications: U.S. Pat. Nos. 8,262,938, 8,277,688, 9,243,333, 9,243,150; Patent Cooperation Treaty Application nos. US15/65301 and US16/16509, all of the foregoing in this paragraph or incorporated herein by reference. In some embodiments, the corrosion inhibitors are relatively insoluble and have a solubility of less than 100 milligrams per liter. In some embodiments, any semisolid phosphate salt may be used in the paste as a corrosion inhibitor.

The paste may include at least one corrosion inhibitor selected from the group comprising a lithium salt, an organic or inorganic lithium salt, lithium phosphate, a cation phosphate, lithium carbonate, at least one metal polycarboxylate, magnesium-containing materials, a cation polycarboxylate, magnesium oxide, oxyaminophosphate salts of magnesium, magnesium carbonate, magnesium phosphate and magnesium hydroxide, magnesium citrate, magnesium oxalate, zinc citrate, zinc oxalate, organometallic compounds and a combination thereof.

A blend of inhibitors may consist of lithium phosphate and at least one inhibitor chosen from the following. Anions: polycarboxylates chosen from linear and branched aliphatic molecules like oxalate, citrate, tartrate, succinate, and adipate, and aromatic molecules like phthalate, diphenate, mellitate, and trimellitate. These are examples of some possible molecules; there are many other polycarboxylates which can be used in the combination. Cations: elements chosen from Group Ila-Magnesium, calcium, strontium, and barium Group IIIB-Scandium, yttrium, lanthanum, and the other lanthanides like cerium, praseodymium, neodymium, samarium, europium, gadolinium, etc. Group IVb-Titanium and zirconium Group Vb-Vanadium and niobium Group VIb-Chromium and molybdenum Group VIIb-Manganese Group VIII-Iron, cobalt, and nickel Group Ib-Copper Group IIb-Zinc Group Illa-Aluminum Group Va-Bismuth.

Corrosion inhibitors may be blended with different molar ratios to obtain the maximum synergistic performance for a particular application. Inhibitors may also be used at varying concentrations in the particular vehicle for the application. Inhibitors may be combined in bulk after synthesis, or they may be blended during synthesis. For example, additional or different synergistic effects may be garnered by reacting oxalic acid with zinc nitrate and magnesium nitrate to achieve a compound with a mixed complex of zinc and magnesium oxalate. The solubility synthesized zinc oxalate and magnesium oxalate compounds.

Corrosion inhibitors may include lithium salts (which may be added to mix 1-80% by volume), metal polycarboxylates or combinations thereof, and chromium-free inhibitors. The corrosion inhibitors may be ionic or organic. The corrosion inhibitors may be lithium free. The corrosion inhibitors may comprise lithium-free synergistic combinations of metal oxalates, metal pirates, metal succinate, metal tartrates, and metal adipate. U.S. Pat. No. 10,351,715 incorporated herein by reference, discloses metal polycarboxylate corrosion inhibitors, one or more of which may be combined into the mix disclosed herein. The corrosion-resistant inhibitors may consist essentially of synergistic combinations of:
A. At least one metal polycarboxylate derived from a stoichiometric reaction of metal compounds and polycarboxylic acids to obtain polycarboxylic metal salts and
B. At least one metal polycarboxylate derived from a stoichiometric reaction of metal compounds and polycarboxylic acids to obtain polycarboxylic metal salts, wherein either the metal or the polycarboxylic acid in at least one of the polycarboxylic metal salt combinations is different from the other combination of polycarboxylic metal salts.

For example, where the corrosion-resistant synergistic combination consists of from about 0.1 to 20 parts by weight of zinc oxalate and from about 0.1 to 20 parts by weight of zinc citrate, it is important that either the zinc or the polycarboxylic acid of the polycarboxylic metal salt of either paragraph (A) or (B) be different. It is important that where the carboxylic metal salts are derived from the stoichiometric reaction of several different metal compounds and several different polycarboxylic acids, it is essential that at least one of the polycarboxylic metal salts has a different anion or cation from any of the other polycarboxylic metal salt.

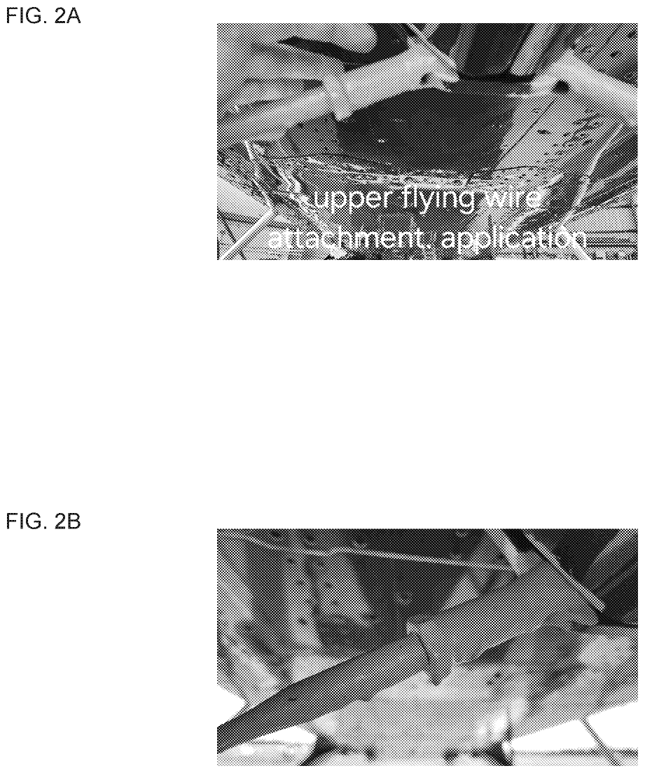

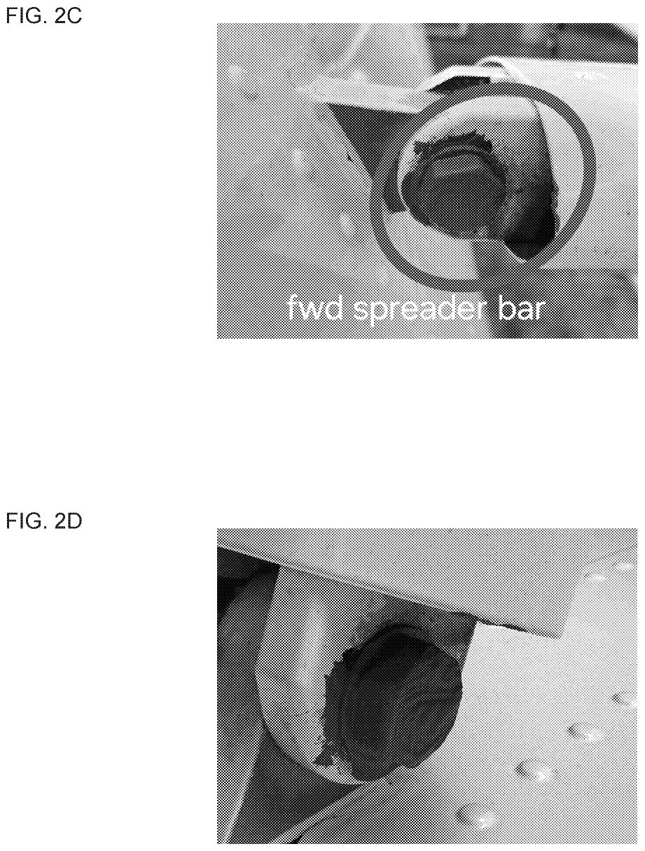

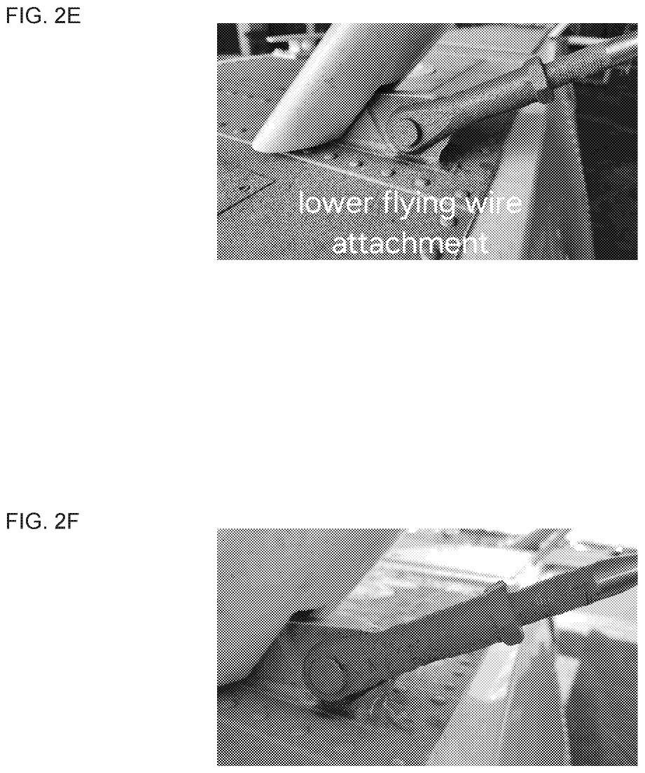

FIG. 2A illustrates the use of corrosion inhibiting cured mix on an aircraft assembly comprising an upper flying wire forked attachment, before exposure (use), the assembly in this embodiment comprising two or more aircraft parts or members threadable attached to the upper wing strut/float attachment point on a float plane. FIG. 2B illustrates the joint of FIG. 2A after exposure. FIG. 2C illustrates the corrosion inhibiting mix on the fastener head attaching a fork at the end of a spreader bar to a float, before exposure. FIG. 2D illustrates the same part after exposure.

FIGS. 2E and 2F are before and after photos of a lower flying wire attachment assembly at the strut/float attachment point.

The exposure described above was on a single engine float plane with about 30 hours of flying time between Florida and the Bahamas, including 12 days in the water on floats and 3 take off and landing cycles, fresh and salt water. After each landing the parts were power washed with fresh water.

“Wet installation” of uncured mix on a fastener (rivet, threaded, screw, etc.) for use on an aircraft part, prior to threaded insertion of the fastener, and around the bolt head is another use of Applicant's RHP mix. Moreover any use of the paste as disclosed herein or as set forth in U.S. patent application Ser. No. 17/817,487, typically 1-10 mil, alone on an aircraft part (without resin and hardener) may be followed by the overcoating of such paste with Applicant's RHP mix, which will harden in due course providing a protective coat thereon.

In some embodiments, the RHP mix may be 2-500 mil thick or in another range 3-50 mil. Applicant's corrosion inhibiting uncured mix may be forced into cracks, small voids, pinholes, gaps, mating areas, and seams and applied to faying surfaces or fasteners. It will provide waterproofing or water resistance, aircraft fluid resistance and corrosion resistant coating in these and other areas, especially on float planes, and the lower fuselage and floats, as well as similarly exposed parts thereof, subject to a wet environment such as during water take off and landing.

In some embodiments the viscosity of paste before mixing into the resin and hardener is between 9,000 and 10,000,000 cP at room temperature and, in some embodiments, may be easily spread at room temperature (no heating required). Viscosity, in some embodiments, may be adjusted by varying the loading of particles and/or corrosion inhibitors. In some embodiments, the viscosity is in the range of 20,000 to 400,000 cP at 20 °C (15,000-750,000 cP in other embodiments).

The RHP mix formulations were found to be effective corrosion inhibiting coatings, especially in low speed, low altitude flights, with for example float or amphibious aircraft, and helicopters. Two formulations COB-01 (Resin, Hardener, Paste with coated metal particles, thickeners and corrosion inhibitors) and COB-02 (Resin, Hardener, Paste with thickeners and corrosion inhibitors) are set forth below.

Curable RHP mix Formulation 10:1

| | | Mass Percentage | Density |
|---|---|---|---|
| Ingredient | 10:1 batch (g) | (Range) | g/ml |
| Epon 862 | 56.25 | 12.89181318 | 1.1743 |
| KBM 903 | 13.275 | 3.04246791 | 1.01 |
| Accel 2950 | 13.275 | 3.04246791 | 1 |
| Siloxane 2000 | 0.561666832 | 0.12872718 | 0.966 |
| D25 | 0.2925 | 0.067037429 | 0.993 |
| COB-01 paste | 352.6692519 | 80.82748639 | 1.59 |
| Total | 436.3234187 | | |

Side A Resin: Epon 862; D25; PAC-05 (Paste).
Side B Hardener: KBM 903; Accel 2950; Siloxane 2000.
Volume Ratio 10:1 (resin:hardener).
Epon 862 is a low viscosity liquid epoxy resin, reacts with a full range of epoxy curatives.
D25 or any appropriate moisture cure catalyst.

COB-01 contains a paste available from AvDEC, Fort Worth, Texas which is a vegetable based oil base (see US2023/0042294, incorporated herein by reference) loaded 40-50%, loaded with passivated coating on Aluminum alloy particles (including either coated in molybdate solution or chromate free, trichromium phosphate solution) 25-35%, and corrosion inhibitors 14-24%, (including a three salt mix of zinc oxalate, zinc citrate and magnesium phosphate) and inert fiber thickeners 1-5% (which fibers also act as a flame retardant, for example fused silica). The foregoing by total mass of paste.
KBM 903 is an amine functionalized silane coupling agent.
Accel 2950 is an amine based epoxy cohardener and accelerator for ambient cure or
thermoset of the resin and the KBM amine based hardener.
Siloxane 2000 is a surfactant, hydrophobic leveling agent.
Hardener side was prepared as follows: shearing under vacuum or hand mix, or any conventional manner, to a viscosity of about 45 cP, or range 10-100 cP.
Resin Side was prepared as follows: shearing under vacuum or hand mix, or any conventional manner, to a viscosity 15,000 cp or 5,000-25,000 cP.

Following mixing of each side they were thoroughly combined at room temperature and immediately subject to rheological testing with the following apparatus: Anton Paar Model 302E, or any other viscometer according to the following protocol: run with frequency and strain amplitude. Frequency 5 Hz. Amplitude: 0.5% of 360 degrees=1.8 degree amplitude. Normal force on plate 0, Fn=0

Side A and Side B are then loaded into an applicator 30, for example that shown in FIG. 1A, or any other known in the art, including for example those available from SEMCO. Applicator will mix and apply the uncured mix,

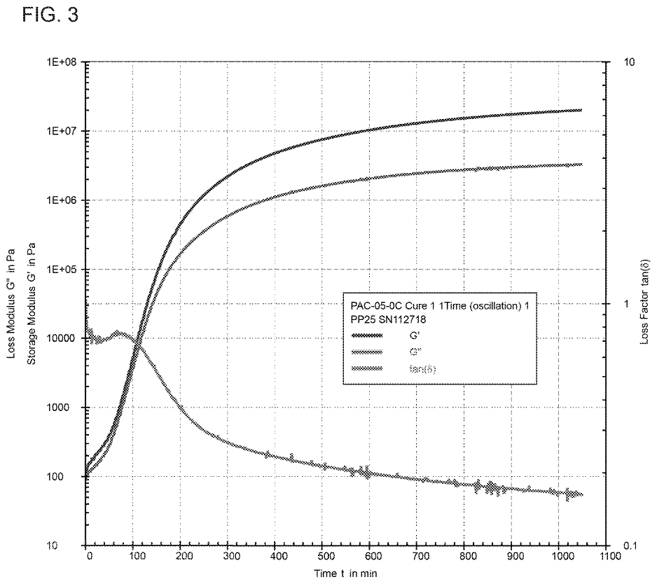

The results of loss and storage modulus and tan delta are set forth in FIG. 3. From this we determined that the mix pot life is about 1 hour at room temperature. Substantial cure 10-12.5 hours (hardness and other physical properties 90%), full cure (tan delta substantially flat) is about 20 hours. Polymeric materials are sometimes viscoelastic and exhibit both viscosity (flow) and elasticity (rebound) to various degrees. Tan delta is the ratio of loss modulus to storage modulus. Applicant has found that a tan delta of about 0.1 provides physical properties that make the polymer coating suitable for the uses set forth herein.

The cured hardness of the product may be about Shore D 31, range Shore D 10-60 or semi-soft.

A bare aluminum alloy coupon with about 30-60 mil thick cured RHP coating was subject to 1000 hours salt fog (ASTM B117) and another to 1000 hours UV (UV index 2-4 on digital Model 6.5 by Solarmeter), with satisfactory results (no visible cracks, deterioration, discoloration, delamination or debonding.

FIG. 4 illustrates spray test fluid exposure, RTCA, Inc. DO 160, section 11 (revG) results which show the cured produce specimen size 30-60 mil thick, has excellent resistance to a broad spectrum of aircraft fluids. FIG. 5 illustrates the weight change upon immersion in the RTCA fluids. Both show satisfactory results.

To demonstrate durability and ease of removability of the cured product, the fresh product when cured on a 2024 T-3 aluminum alloy sheet, at about 30 mil thick, was sprayed from 2-3 feet with the green (25 degrees) nozzle of a 3000 psi DeWalt power washer at max pressure. No visible removal of product after 5 minutes of spraying at various angles. At 3″-6″, however, the product removed cleanly after several sweeps, holding spray about 45 degrees.

The fresh product can also be easily removed with a plastic windshield ice scraper. A coupon of freshly cured product on an aluminum alloy coupon, the product about 30-50 mil thick, is easily removed with the 4″ wide 1/16″ blade edge plastic scraper placed about 45 degrees to the edge of the cured product, using about 2-10 pounds of force.

Thus the product is easily removed when required but is durable in use.

COB-01 contains a paste with aluminum alloy particles coated with a semiconductive coating and other ingredients as set forth herein. COB-02 contains a paste (AFC) that has no metal particles, but does have 29-39% by mass of corrosion inhibitors (same mix used in COB-01), 55-65% vegetable oil base and 1.6-7.6% thickeners (same thickeners as COB-01). All mass percentages of total mass of paste. In addition, see below, Side A has lightweight thermoplastic microspheres, here Expancel Nouryon d40 (40 mil dia). They are used as a flowing agent, a suspension agent and to lessen the overall density of the product, as the microspheres are typically about 0.5-0.9 sp gr.

COB-02
For 200 cc Cartridge

| Ingredient | B Volume | B mass (g) | A Volume | A mass (g) |
|---|---|---|---|---|
| Epon 862 | | | 31.93391808 | 37.5 |
| KBM 903 | 8.762376238 | 8.85 | | |
| Accel 2950 | 8.85 | 8.85 | | |
| Siloxane 2000 | 0.387623762 | 0.374444554 | | |
| D25 | | | 0.196374622 | 0.195 |
| AFC paste | | | | 131.75 |
| Nouryon (hollow | | | | 2 |
| spheres) | | | | |
| Total | 18 | | 180 | |

Ball Mill AFC 5-10 times

400 rpm for 10 minutes under full vacuum before addition into side A

Side A resin and Side B hardener are mixed as COB-01.

Both mixes exhibit good corrosion prevention, durability and ease or removal in aircraft real world testing.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A corrosion inhibiting epoxy coating for aircraft use including use on an aircraft part, the corrosion inhibiting epoxy coating comprising the reaction product of:
a paste;
an epoxy resin; and
a hardener.

2. The reaction product of claim 1 further including particles.

3. The reaction product of claim 2 wherein the particles are coated or uncoated metal particles.

4. The reaction product of claim 3 wherein the metal particles are aluminum alloy coated with a semi-conductive coating.

5. The reaction product of claim 4 further including non-metal corrosion inhibitors.

6. The reaction product of claim 4 wherein the coating is a TCP (Trivalent Chromium Passivation).

7. The reaction product of claim 4 wherein the coating is a molybdate coating.

8. The reaction product of claim 2 wherein the inert particles are polymers.

9. The reaction product of claim 1 wherein: the paste is a vegetable-based oil base loaded 40-50%, loaded with passivated coating on aluminum alloy particles (including either coated in molybdate solution or chromate free, trichromium phosphate solution) 25-35%, and corrosion inhibitors 14-24%, (including a three salt mix of zinc oxalate, zinc citrate and magnesium phosphate) and inert fiber thickeners 1-5% (which fibers also act as a flame retardant, for example fused silica), foregoing by total mass of paste.

10. The reaction product of claim 9 further including particles wherein the particles are loaded at a range of 10 to 85 percent of the total product mass.

11. The reaction product of claim 5 further includes nonmetal corrosion inhibitors, wherein the corrosion inhibitors are loaded at 10-40 percent total mass.

12. The reaction product of claim 5 wherein said non-metal corrosion inhibitors include one or more of a: lithium salt, a mixed complex of zinc and magnesium oxalate, a metal polycarboxylate, a magnesium salt, a phosphate salt, or is a chromium-free corrosion inhibitor.

13. The reaction product of claim 5, wherein the corrosion inhibitor is ionic, a covalent organometallic, or organic.

14. The reaction product of claim 5, including at least one corrosion inhibitor selected from the group comprising: a lithium salt, an organic or inorganic lithium salt, lithium phosphate, a cation phosphate, lithium carbonate, at least one metal polycarboxylate, non-metallic magnesium-containing materials, a cation polycarboxylate, magnesium oxide, oxyaminophosphate salts of magnesium, magnesium carbonate and magnesium hydroxide, magnesium citrate, magnesium oxalate, zinc citrate, zinc oxalate, organometallic compounds and combinations thereof.

15. The reaction product of claim 3, wherein the corrosion inhibitor is lithium free.

16. The reaction product of claim 3 wherein the cured epoxy coating passes the 3000-hour salt fog test on an aluminum alloy substrate.

17. The reaction product of claim 3 wherein the hardness is between Shore D 10-60.

18. The reaction product of claim 3 wherein the metal particles are one or more of the following: aluminum, magnesium, zinc, or alloys thereof.

19. A method of protecting an aircraft made at least partly aluminum, magnesium, titanium, or an alloy of any of the forgoing, or steel, the method comprising:
coating the part with the reaction product of claim 1.

20. The method of claim 19 wherein the part includes a surface of at least one of the follow: a fastener, a float, a spreader bar, a flying wire.

21. A durable corrosion resistant epoxy polymer coating for use on an aircraft part the polymer coating comprising: a polymer binder capable of being brushed or spatula applied to the aircraft substrate and hardening to a plastic consistency, wherein said hardened polymer binder is further capable of remaining adhered to an aircraft substrate after being subject to power wash test and being capable of removal with a plastic scraping tool exerting about 2 to 10 psi pressure at an edge of said hardened polymer binder.
